(19) United States
(12) Patent Application Publication
(10) Pub. No.: US 2026/0132881 A1
(43) Pub. Date: May 14, 2026

(54) Quick-Assembly Adapter

(71) Applicant: Chien-Ting Lin, Santa Fe Springs, CA (US)

(72) Inventor: Chien-Ting Lin, Santa Fe Springs, CA (US)

(21) Appl. No.: 19/382,504

(22) Filed: Nov. 7, 2025

(30) Foreign Application Priority Data
Nov. 8, 2024 (CN) 202422726817.9

(51) Int. Cl. F16M 11/04; F16H 55/17

(52) U.S. Cl. CPC F16M 11/041; F16H 55/17; F16H 2055/176

(57) ABSTRACT

Provided is a quick-assembly adapter, wherein a screw fastener is accommodated within a central accommodating portion of a base, a rotating ring is sleeved around fixing portions of the base, each of gear accommodating portions of the base accommodates two horizontally adjacent second gears, second teeth of the two adjacent second gears are meshed with each other, the second teeth close to the central accommodating portion are meshed with first teeth of a first gear of the screw fastener, the second teeth close to the rotating ring are meshed with inner teeth of the rotating ring, and fasteners fix a carrying member with the base. When rotating the rotating ring, the inner teeth drive the second teeth, making the two adjacent second gears rotate in opposite directions, and the second teeth drive the first teeth, such that the screw fastener rotates in a direction same as the rotating ring.

### CROSS-REFERENCE TO RELATED APPLICATION

This application claims the priority of Chinese patent application No. 202422726817.9, filed on Nov. 8, 2024, which is incorporated herewith by reference.

### BACKGROUND OF THE INVENTION

### 1. Field of the Invention

The present invention relates to a quick-assembly adapter, in particular to a quick-assembly adapter without an outer frame.

### 2. The Prior Arts

Conventional quick-assembly adapters, such as common quick-assembly adapters for cameras, include a disc with a screw rod and an outer frame enclosing a periphery of the disc. The screw rod is disposed at a center of the disc and perpendicular to a circular surface of the disc. The outer frame is arranged adjacent to the periphery of the disc with a slight gap therebetween. The outer frame has an upper outer frame surface, a lower outer frame surface, and two side outer frame surfaces. The screw rod of the disc passes through a center of the upper outer frame surface, and the lower outer frame surface may be provided with different connection structures to connect to other objects such as a tripod according to needs. The two side outer frame surfaces wrap around both sides of the disc to support the upper and lower outer frame surfaces. When the disc is rotated, the screw rod may be rotated synchronously. The interface of the camera or other equipment is aligned with the screw rod and by rotating the disc, the camera or other equipment may be tightly connected with the upper outer frame surface. During installation, there is no need to rotate the camera or other equipment but only need to rotate the disc, which may effectively reduce the risk of accidentally dropping the camera or other equipment during their rotation.

However, the side outer frame surfaces of the conventional quick-assembly adapter cover a part of the side surface of the disc, thereby causing the hand to be blocked when rotating the disc. Also, the disc and the screw rod of the conventional structure must be assembled separately. Due to the outer frame, the size of this structure is made relatively small in order to control cost and volume, which makes it inconvenient in use.

Further, another conventional quick-assembly adapter is not provided with an outer frame, in which gears disposed therein are used to drive the screw rod. The gears are disposed at upper and lower layers. If a height of the gears is too small, it will affect the stability during rotation; if the height of the gears is too large, an overall height of the quick-assembly adapter must be increased accordingly. Moreover, since the upper and lower gears share the same shafts, if the manufacturing precision is insufficient, the gears cannot be rotated smoothly. However, if the manufacturing precision is high, more resources and costs are required. The overall size and height of the conventional quick-assembly adapter are limited and cannot be made smaller, and the high precision is required, otherwise the rotation will not be smooth.

### SUMMARY OF THE INVENTION

In order to overcome the problems of the conventional quick-assembly adapters, including being blocked during rotation, the overall height being limited and unable to be made smaller, and being prone to unsmooth rotation, the present invention provides a quick-assembly adapter without an outer frame, wherein a fixing portion is supported between a carrying member and a base; a gear accommodating portion is disposed between side walls of the fixing portion; a second gear is accommodated within the gear accommodating portion; a central accommodating portion is disposed in a center of an annular area defined by the fixing portion and the gear accommodating portion; and a screw fastener is accommodated within the central accommodating portion. The present invention has an enough space to increase the lengths of second teeth and first teeth, thereby enhancing stability during rotation, without the need in increasing the overall height of the quick-assembly adapter, and eliminating the inconvenience caused by the outer frame of the conventional structures.

To address the aforementioned technical problems, the present invention provides a technical solution of a quick-assembly adapter, comprising: a carrying member having a central hole and at least one first fixing hole; a rotating ring being an annular body with a large through hole at a center thereof, and the rotating ring circumferentially provided with inner teeth on an inner side thereof; a screw fastener provided with a first gear at one end, the first gear having first teeth; a base including a base surface and a connecting portion, wherein the base surface is vertically provided with a central accommodating portion, at least one fixing portion and at least one gear accommodating portion, the at least one fixing portion and the at least one gear accommodating portion are horizontally arranged around a periphery of the central accommodating portion, the at least one gear accommodating portion is disposed between side walls of the at least one fixing portion and communicated with the central accommodating portion, the at least one fixing portion has at least one second fixing hole, and a number of the at least one second fixing hole is equal to a number of the at least one first fixing hole; at least one second gear each having second teeth, wherein a number of the at least one second gear is twice a number of the at least one gear accommodating portion; and at least one fastener, a number of which is equal to the number of the at least one first fixing hole, wherein in assembling, the screw fastener is accommodated within the central accommodating portion, the rotating ring is sleeved around a periphery of the at least one fixing portion, each gear accommodating portion accommodates two horizontally adjacent second gears, the second teeth of the two adjacent second gears are meshed with each other, the second teeth of the second gears close to the central accommodating portion are meshed with the first teeth, the second teeth of the second gears close to the rotating ring are meshed with the inner teeth, the carrying member covers the at least one fixing portion, the screw fastener extends to outside through the center hole, and the at least one first fixing hole is aligned with and fastened to the at least one second fixing hole by the at least one fastener, thereby fixing the carrying member and the base to each other; when the rotating ring is rotated, the inner teeth drive the second teeth, making the two adjacent second gears rotate in opposite directions, and the second teeth drive the first teeth, such that the screw fastener rotates in a direction same as that of the rotating ring.

Preferably, the number of the at least one second gear is reduced by half, that is, the number of the at least one second gear is equal to the number of the at least one gear accommodating portion. Each gear accommodating portion accommodates one second gear, the second teeth of the second gear close to the central accommodating portion are meshed with the first teeth, and the second teeth of the second gear close to the rotating ring are meshed with the inner teeth. When the rotating ring is rotated, the inner teeth drive the second teeth, and the second teeth drive the first teeth, such that the screw fastener rotates in a direction opposite to that of the rotating ring.

The beneficial effect of the present invention is that the fixing portion is supported between the carrying member and the base; the gear accommodating portion is disposed between side walls of the fixing portion; the second gear is accommodated within the gear accommodating portion; the central accommodating portion is disposed in the center of the annular area defined by the fixing portion and the gear accommodating portion; and the screw fastener is accommodated within the central accommodating portion. The present invention has an enough space to increase the lengths of the second teeth and the first teeth, thereby enhancing stability during rotation, without the need in increasing the overall height of the quick-assembly adapter, and eliminating the inconvenience caused by the outer frame of the conventional structures.

### BRIEF DESCRIPTION OF THE DRAWINGS

The present invention will be further described below with reference to the accompanying drawings and embodiments.

FIG. 1 is a schematic view of the first embodiment of the present invention;

FIG. 2 is an exploded schematic view of the first embodiment of the present invention;

FIG. 3 is an assembled view of the first embodiment of the present invention;

FIG. 4 is a schematic view of the first embodiment of the present invention without a rubber pad assembled;

FIG. 5 is a schematic view of the first embodiment of the present invention with a rubber pad assembled; and

FIG. 6 is an assembled view of the second embodiment of the present invention.

### DETAILED DESCRIPTION OF THE PREFERRED EMBODIMENT

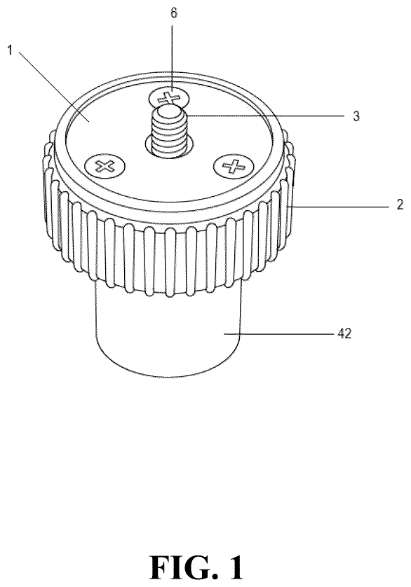

Embodiments of the present invention will be described below with reference to FIGS. 1 to 6. This description is not intended to limit the implementation of the present invention, but is an example of the present invention.

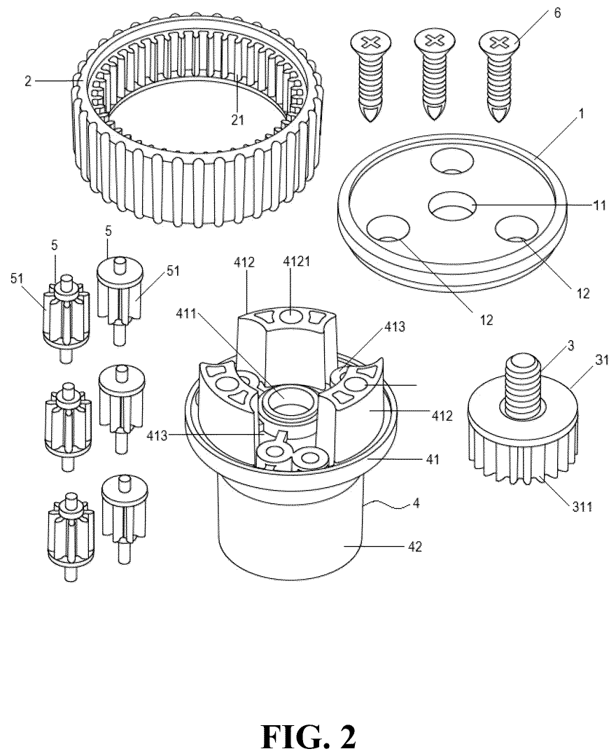

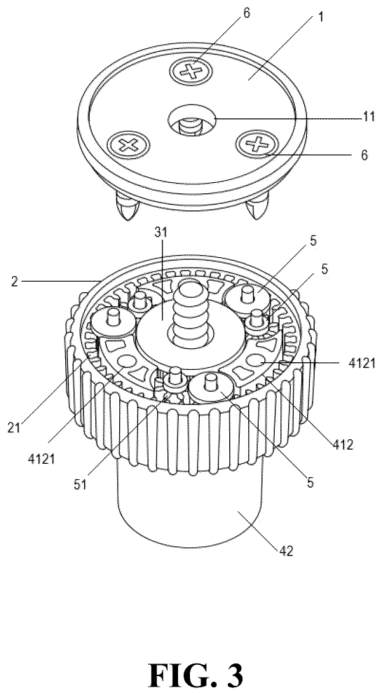

As shown in FIGS. 1 to 3, a quick-assembly adapter according to a first embodiment of the present invention comprises: a carrying member 1, a rotating ring 2, a screw fastener 3, a base 4, at least one second gear 5, and at least one fastener 6. As shown in FIG. 2, the carrying member 1 has a central hole 11 and at least one first fixing hole 12. The rotating ring 2 is an annular body with a large through hole at a center thereof, and the rotating ring 2 is circumferentially provided with inner teeth 21 on an inner side thereof. The screw fastener 3 is provided with a first gear 31 at one end, and the first gear 31 has first teeth 311. The base 4 includes a base surface 41 and a connecting portion 42. The base surface 41 is vertically provided with a central accommodating portion 411, at least one fixing portion 412 and at least one gear accommodating portion 413. The at least one fixing portion 412 and the at least one gear accommodating portion 413 are horizontally arranged around a periphery of the central accommodating portion 411. The at least one gear accommodating portion 413 is disposed between side walls of the at least one fixing portion 412 and communicated with the central accommodating portion 411. The fixing portion 412 has at least one second fixing hole 4121, wherein the number of the at least one second fixing hole 4121 is equal to the number of the at least one first fixing hole 12. The at least one second gear 5 each has second teeth 51, wherein the number of the at least one second gear 5 is twice the number of the at least one gear accommodating portion) 413. The number of the at least one fastener 6 is equal to the number of the at least one first fixing hole 12. As shown in FIG. 3, in assembling, the screw fastener 3 is accommodated within the central accommodating portion 411, and the rotating ring 2 is sleeved around a periphery of the at least one fixing portion 412. Each gear accommodating portions 413 accommodates two horizontally adjacent second gears 5. The second teeth 51 of the two adjacent second gears 5 are meshed with each other, wherein the second teeth 51 of the second gears 5 close to the central accommodating portion 411 are meshed with the first teeth 311, and the second teeth 51 of the second gears 5 close to the rotating ring 2 are meshed with the inner teeth 21. The carrying member 1 covers the at least one fixing portion 412. The screw fastener 3 extends to the outside through the center hole 11, and the at least one first fixing hole 12 is aligned with and fastened to the at least one second fixing hole 4121 by the at least one fastener 6, thereby fixing the carrying member 1 and the base 4 to each other. As shown in FIG. 1, when the rotating ring 2 is rotated, the inner teeth 21 drive the second teeth 51, making the two adjacent second gears 5 rotate in opposite directions, and the second teeth 51 drive the first teeth 311, such that the screw fastener 3 can rotate in a direction same as that of the rotating ring 2. The present invention is essentially configured such that the fixing portion 412 is supported between the carrying member 1 and the base 4; the gear accommodating portion 413 is disposed between the side walls of the fixing portions 412; the second gear 5 is accommodated within the gear accommodating portion 413; the central accommodating portion 411 is disposed in a center of an annular area defined by the fixing portions 412 and the gear accommodating portions 413; and the screw fastener 3 is accommodated within the central accommodating portion 411. The present invention has an enough space to increase the lengths of the second teeth 51 and the first teeth 311, thereby enhancing stability during rotation, and eliminating the inconvenience in use caused by the outer frame of the conventional structures.

As shown in FIG. 2, according to the first embodiment of the present invention, the carrying member 1 may have three first fixing holes 12, wherein the base surface 41 is provided with three fixing portions 412 and three gear accommodating portions 413, and each fixing portion 412 has one second fixing hole 4121; and six second gears 5 and three fasteners 6 may be provided. The screw fastener 3 is accommodated within the central accommodating portion 411, and the rotating ring 2 is sleeved around the periphery of the fixing portions 412. Each gear accommodating portion 413 accommodates two horizontally adjacent second gears 5. The second teeth 51 of the two adjacent second gears 5 are meshed with each other, wherein the second teeth 51 of the second gears 5 close to the central accommodating portion 411 are meshed with the first teeth 311, and the second teeth 51 of the second gears 5 close to the rotating ring 2 are meshed with the inner teeth 21. The carrying member 1 covers the fixing portions 412. The screw fastener 3 extends to the outside through the center hole 11, and the first fixing holes 12 are aligned with and fastened to the second fixing holes 4121 by the fasteners 6, thereby fixing the carrying member 1 and the base 4 to each other. When the rotating ring 2 is rotated, the inner teeth 21 drive the second teeth 51, making the two adjacent second gears 5 rotate in opposite directions, and the second teeth 51 drive the first teeth 311, such that the screw fastener 3 can rotate in a direction same as that of the rotating ring 2. In the first embodiment of the present invention, the purpose of adopting three first fixing holes 12, three fixing portions 412, three gear accommodating portions 413, three second fixing holes 4121, six second gears 5, and three fasteners 6 is to provide better stability.

As shown in FIG. 1, the screw fastener 3 according to the first embodiment of the present invention may be a screw, which can be fastened with a nut of a connector of an external device or accessory through the center hole 11. In other embodiments of the present invention, the screw fastener 3 may be substituted by other components such as a nut, which may be fastened with a screw of the connector of the external device or accessory through the central hole 11.

As shown in FIG. 1, the connecting portion 42 according to the first embodiment of the present invention may be in a shape of circular tube and may be used for connecting with a tubular or columnar bracket. In other embodiments of the present invention, the connecting portion 42 may be substituted by other shapes of connecting portion.

As shown in FIG. 2, the first gear 31 and the second gear 5 according to the first embodiment of the present invention may be a type of spur gear. In other embodiments of the present invention, the first gear 31 and the second gear 5 may be substituted by other types of gear.

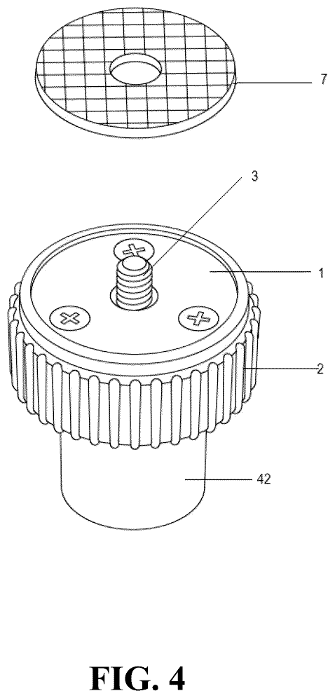

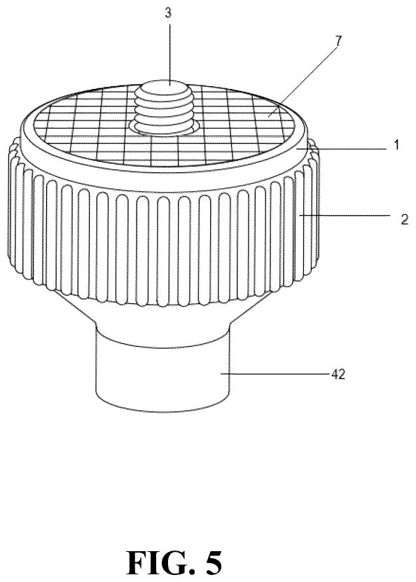

As shown in FIGS. 4 to 5, according to the first embodiment of the present invention, a rubber pad 7 may be attached on the carrying member 1. The rubber pad 7 can prevent a surface of the carrying member 1 from directly contacting the external devices or accessories, and can increase the fit and anti-slip properties.

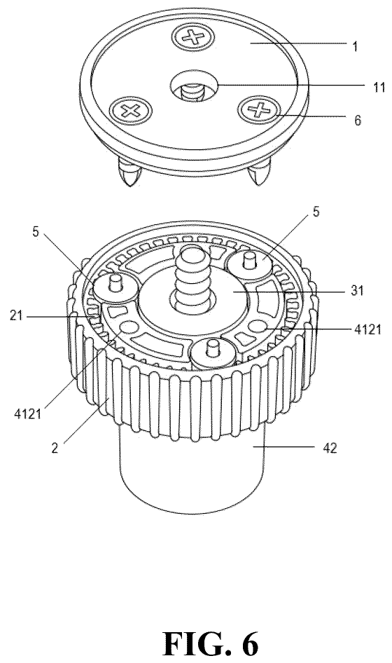

As shown in FIG. 6, according to a second embodiment of the present utility, the number of the at least one second gear 5 may be reduced by half, that is, the number of the at least one second gear 5 is equal to the number of the at least one gear accommodating portion 413. Each gear accommodating portion 413 accommodates one second gear 5, the second teeth 51 of the second gear 5 close to the central accommodating portion 411 are meshed with the first teeth 311, and the second teeth 51 of the second gear 5 close to the rotating ring 2 are meshed with the inner teeth 21. When the rotating ring 2 is rotated, the inner teeth 21 drive the second teeth 51, and the second teeth 51 drive the first teeth 311, such that the screw fastener 3 rotates in a direction opposite to that of the rotating ring 2. According to the second embodiment of the present invention, the rotation direction of the rotating ring 2 is opposite to the rotation direction of the screw fastener 3, which may be applied to the equipment with such requirements.

According to the first and second embodiments of the present invention, it can be seen that when the number of the second gears 5 in each gear accommodating portion 413 is two or an even number, the rotation direction of the rotating ring 2 will be the same as the rotation direction of the screw fastener 3. In contrast, when the number of the second gears 5 in each gear accommodating portion 413 is one or an odd number, the rotation direction of the rotating ring 2 will be opposite to the rotation direction of the screw fastener 3.

The above description and explanation are only illustrations for the preferred embodiments of the present invention. Those skilled in the art may make other modifications based on the scope to be protected defined by the claims and the above description. Such modifications should still be considered as falling within the spirit of the present invention and should be encompassed within the scope of the present invention.

What is claimed is:

1. A quick-assembly adapter, comprising:
a carrying member having a central hole and at least one first fixing hole;
a rotating ring being an annular body with a large through hole at a center thereof, and the rotating ring circumferentially provided with inner teeth on an inner side thereof;
a screw fastener provided with a first gear at one end, the first gear having first teeth;
a base including a base surface and a connecting portion, wherein the base surface is vertically provided with a central accommodating portion, at least one fixing portion and at least one gear accommodating portion, the at least one fixing portion and the at least one gear accommodating portion are horizontally arranged around a periphery of the central accommodating portion, the at least one gear accommodating portion is disposed between side walls of the at least one fixing portion and communicated with the central accommodating portion, the at least one fixing portion has at least one second fixing hole, and a number of the at least one second fixing hole is equal to a number of the at least one first fixing hole;
at least one second gear each having second teeth; and
at least one fastener, a number of which is equal to the number of the at least one first fixing hole,
wherein in assembling, the screw fastener is accommodated within the central accommodating portion, the rotating ring is sleeved around a periphery of the at least one fixing portion, each gear accommodating portion accommodates the at least one second gear, the second teeth of the second gears close to the central accommodating portion are meshed with the first teeth, the second teeth of the second gears close to the rotating ring are meshed with the inner teeth, the carrying member covers the at least one fixing portion, the screw fastener extends to outside through the center hole, and the at least one first fixing hole is aligned with and fastened to the at least one second fixing hole by the at least one fastener, thereby fixing the carrying member and the base to each other; when the rotating ring is rotated, the inner teeth drive the second teeth, and the second teeth drive the first teeth, such that the screw fastener rotates in a direction same as or opposite to that of the rotating ring.

2. The quick-assembly adapter according to claim 1, wherein a number of the at least one second gear is twice a number of the at least one gear accommodating portion, each gear accommodating portion accommodates two horizontally adjacent second gears, the second teeth of the two adjacent second gears are meshed with each other, the second teeth of the second gear close to the central accommodating portion are meshed with the first teeth, the second teeth of the second gear close to the rotating ring are meshed with the inner teeth, when the rotating ring is rotated, the inner teeth drive the second teeth, making the two adjacent second gears rotate in opposite directions, and the second teeth drive the first teeth, such that the screw fastener rotates in the direction same as that of the rotating ring.

3. The quick-assembly adapter according to claim 1, wherein a number of the at least one second gear is equal to a number of the at least one gear accommodating portion, each gear accommodating portion accommodates one second gear, the second teeth of the second gear close to the central accommodating portion are meshed with the first teeth, the second teeth of the second gear close to the rotating ring are meshed with the inner teeth, when the rotating ring is rotated, the inner teeth drive the second teeth, and the second teeth drive the first teeth, such that the screw fastener rotates in the direction opposite to that of the rotating ring.
